(19) United States
(12) Patent Application Publication
(10) Pub. No.: US 2026/0257790 A1
(43) Pub. Date: Sep. 3, 2026

(54) Aircraft System and Launching Method and Apparatus

(71) Applicant: FUCHSZEUG B.V., Rotterdam (NL)

(72) Inventors: Reinhart Paelinck, Rotterdam (NL); Kevin Rand, Rotterdam (NL); Muscan Karadayi, Rotterdam (NL); Ehsan Tofigh, Rotterdam (NL)

(73) Assignee: FUCHSZEUG B.V., Rotterdam (NL)

(21) Appl. No.: 19/489,166

(22) PCT Filed: Jun. 6, 2024
(86) PCT No.: PCT/EP2024/065670

§ 371 Date: Dec. 1, 2025

(30) Foreign Application Priority Data
Jun. 9, 2023 (GB) 202308656

(51) Int. Cl. B64C 19/00; B64C 31/02; B64C 39/02; B64F 3/00; G05D 1/678

(52) U.S. Cl. CPC B64C 19/00; B64C 31/02; B64C 39/022; B64F 3/00; G05D 1/678

(57) ABSTRACT

A method of controlling the altitude and/or velocity of a tethered aircraft, the method comprising the steps of: a charging phase, in which the energy of the aircraft is increased, a conversion phase following the charging phase, in which the increased energy is utilised to increase the altitude and/or velocity of the aircraft; a gliding phase, in which the aircraft is positioned for a further charging phase and conversion phase; and repeating the charging phase and conversion phase at least once.

### FIELD OF THE INVENTION

The present invention concerns aircraft and a method of controlling the altitude and/or velocity of an aircraft. More particularly, but not exclusively, this invention concerns a method and apparatus to control the altitude and/or velocity of an aircraft without needing to utilise an engine or other power unit on the aircraft itself.

### BACKGROUND OF THE INVENTION

The skilled person will be familiar with the winch launching, or tow vehicle launching, of sail planes such as gliders. With winch launching, the sail planes are pulled along the ground until they reach a speed that the aerodynamic forces acting on the wings of the aircraft provide sufficient lift to overcome the weight of the aircraft, resulting in the launch of the aircraft from the ground. However, there are limitations of this technique, as the launching process requires a relatively long runway, and the length of the runway also limits the altitude gain of the launching technique. With tow launching, an aircraft may be launched at higher altitude, but the process is dependent on a secondary towing aircraft. A winch or tow launch may offer advantages over thrust providers, for example jet engines or propellors, being added to an aircraft. The launch process may be quieter, and it may be more energy efficient. The aircraft design may also be more straightforward, or optimised for efficient flight as a result of not needing thrust providers, but the technique introduces other unique considerations such as structural placement of the tether connection interface. However, the limitations of the technique as described above means that winch or tow launching is not suitable for many types of aircraft, and many types of desired flight paths.

The present invention seeks to mitigate the above-mentioned problems. Alternatively or additionally, the present invention seeks to provide an improved apparatus and method for controlling the altitude and velocity of an aircraft.

### SUMMARY OF THE INVENTION

According to a first aspect, the invention provides a method, which may be referred to as tethered propulsion, of controlling the altitude and/or velocity of a tethered aircraft, the method comprising the steps of:
a charging phase, in which the energy of the aircraft is increased,
a conversion phase following the charging phase, in which the increased energy is utilised to increase the altitude and/or velocity of the aircraft;
a gliding phase, in which the aircraft is positioned for a further charging phase and conversion phase;
repeating the charging phase and conversion phase at least once.

The charging phase may comprise energy being transferred to the aircraft via external means to the aircraft, for example via the tether, or via the wind conditions experienced by the aircraft. The charging phase is not reliant on increased energy to the aircraft being provided by an engine or the like forming part of the aircraft.

The charging phase may comprise the tension in the tether being increased, for example by the tether being retracted by a winch and thereby imparting additional kinetic energy to the aircraft. The tether may directly increase the velocity of the aircraft, and the conversion phase may utilise this increased velocity to increase the altitude of the aircraft with appropriate manipulation of flight control surfaces of the aircraft. The charging phase may comprise flight control surfaces of the aircraft being manipulated to increase the lift imparted by the wind conditions experienced by the aircraft, and the conversion phase may utilise this increased lift to increase the altitude of the aircraft. The gliding phase may comprise the tension in the tether decreasing, for example as the aircraft is positioned for the next charging phase. The positioning of the aircraft may be reliant on weather conditions, for example positioning the aircraft to experience increased lift as described above, or positioning the aircraft for retraction of the tether by a winch, as most appropriate.

Advantageously, the invention allows the altitude and/or velocity of a tethered aircraft to be increased in an efficient manner. The invention also allows the altitude and/or velocity of the tethered aircraft to be increased without the need to engage a propulsion mechanism, for example engines, on the tethered aircraft. This may allow the altitude and/or velocity of an unpowered aircraft, for example, a sail plane, to be increased. Alternatively or additionally, this may allow the altitude and/or velocity of a powered aircraft to be increased without the need to engage the engines of the aircraft, or potentially reducing the amount of power required by the engines of the aircraft. The invention may allow an aircraft to be designed with greater emphasis on efficient flight once the aircraft is off the ground, as the conventional requirements for an aircraft powered take off and potentially landing, are reduced or eliminated.

The conversion phase may comprise flight control surfaces on the aircraft being manipulated to increase the altitude of the aircraft, utilising the increased velocity of the aircraft generated as a result of the charging phase.

The charging phase may comprise the altitude of the aircraft increasing due to the weather conditions, for example the wind conditions, experienced by the aircraft, and the appropriate control of flight control surfaces on the aircraft to increase the lift experienced by the aircraft.

The method may comprise the step of cycling through repeated charging phases, conversion phases, and gliding phases. The method may cycle through repeated charging phases, conversion phases and gliding phases until the desired aircraft altitude is reached. The method may comprise actively managing the tension in the tether to facilitate the change between the charging phases, conversion phases, and gliding phases. The method may comprise actively managing the length of the tether to facilitate the change between the charging phases, conversion phases, and gliding phases.

The method may comprise untethering the aircraft once the desired altitude is reached. The aircraft may comprise a connection point releasably connected to the tether. The aircraft may be connected to a tether platform, the tether platform being connected to the tether. The aircraft may be releasably connected to the tether platform, and the aircraft may be released for example once the desired aircraft altitude and/or velocity is reached. The tether platform may comprise a mating interface arranged to mate with a corresponding mating interface on the aircraft. The mating interface may comprise a controllable release mechanism, such that the aircraft may be released from the tether platform once the desired altitude is reached. The controllable release mechanism may comprise one or more actuators which are controllable to release the mating interface of the tether platform from the mating interface on the aircraft. The tether platform may comprise a cradle, the cradle arranged to be releasably connected to the aircraft. The cradle may support the aircraft at multiple points, potentially increasing the structural resilience of the aircraft during the increase in altitude and/or velocity. The tether platform may comprise a mothership to which the aircraft is releasably connected. The mothership may support a plurality of aircraft simultaneously. The mothership may comprise aerodynamic surfaces and/or flight control surfaces which allow the mothership to remain flying after the release of the aircraft. The mothership may comprise aerodynamic surfaces, and/or flight control surfaces, which provide additional aerodynamic lift to the aircraft.

The aircraft may comprise thrust provision, such as a jet engine or propellors, which are powered up once the desired altitude and/or velocity is reached, and prior to the aircraft being released from the tether. Alternatively, the aircraft may be a sail aircraft and continue on a flight pattern suitable for the aircraft in light of the incumbent weather conditions.

The method may comprise operating the aircraft using tethered propulsion to maintain the aircraft's altitude by alternating between charging, conversion and gliding phases. This may be combined with the thrust provision. Such an arrangement may enable tighter control of the altitude of the aircraft, and may enable the aircraft to remain in flight for extended periods, potentially indefinitely, for example to survey a fixed area. The aircraft may have an electrical ground connection, for example via a wired connection linked to the tether, which may be configured to supply power to the thrust provision of the aircraft and/or ancillary equipment of the aircraft.

The method may comprise the step of tether recovery. The method of tether recovery may include one or more of, hover control, glide control, propeller, or parachute tether recovery. Parachute recovery may comprise deploying a parachute from the tether or tether platform once the aircraft has been untethered. Such an arrangement may provide for the safe and controlled descent of the tether and/or tether platform once the aircraft has been untethered. Hover control may comprise activating a powered flight system, for example a drone, attached to the tether once the aircraft has been untethered to allow safe and controlled descent or reattachment of the tether and/or tether platform. The tether and/or tether platform may be attached to different aircraft once the tether and/or tether platform has been untethered from the initial aircraft. Glide control may comprise the use of a glider to suspend the airborne tether length. As the ground winch reels in the tether, the glider may maintain minimum tension on the tether and contain the airborne tether length within a pre-defined controlled ground area. Propeller recovery may comprise the use of a passive or actively controlled propeller. The propeller may add lift and reduce the terminal velocity of the tether.

The tether may be spooled around the winch drum of a winch. The winch may be powered to reel the tether in and out by winding and unwinding the tether around the winch drum. The winch may be controlled by a control system to reel the tether in and out by winding and unwinding the tether around the winch drum. The method may comprise the step of the aircraft collecting flight telemetry data. The method may comprise the step of collecting weather data, for example wind speed and direction, in the vicinity of the aircraft, for example with a sensor unit forming part of the aircraft, and/or a sensor unit attached to the tether. The method may comprise the step of analysing the flight telemetry data and/or weather data and controlling the charging phases, conversion phases, and gliding phases in dependence on the analysis. The control system may control the winch in dependence on the analysis of the flight telemetry data and/or weather data.

The method may comprise the aircraft starting off stationary on the ground. The method may comprise a method of launching an aircraft from the ground. Alternatively, the method may comprise a method of increasing the altitude and/or velocity of an aircraft already airborne, for example an aircraft with vertical take-off capabilities, or may comprise a method of extending an aircraft range by the aircraft flying from one winch to another winch. The method may comprise a method of increasing the altitude of an aircraft already in the air. The aircraft may comprise a vertical take-off or thrust vectoring system, which may be used to aerially position the aircraft downwind of the winch to ‘transition into a tethered propulsion launch.

The method may comprise the step of connecting the tether to the aircraft. The method may comprise the step of connecting the tether to the aircraft when the aircraft is on the ground. The method of connecting the tether to the aircraft may comprise the step of using a powered flight system, for example a drone, to carry the free end of the tether to the aircraft, connect the tether to the aircraft and then separate from the aircraft and tether. Alternatively, the flight powered system may remain connected to the tether and the aircraft. This enables connection of the tether without the presence of human personnel and allows the drone to support the tether when it is later released from the aircraft. The method of connecting the tether to the aircraft may comprise using a self-powered ground vehicle to carry the free end of the tether to an aircraft. The aircraft or the vehicle may have mechanisms in place to connect the tether to the aircraft. The ground vehicle may then disconnect itself from the tether. Alternatively, or additionally, smaller winches may be located on either end of the air strip to position the end of the tether with respect to the aircraft. The connection methods may enable the tether to be connected to the aircraft without the presence of human personnel, this may improve the safety and efficiency of the system.

The method may comprise the step of changing the direction of travel of the aircraft during the charging phases, conversion phases, and/or gliding phases. For example, the method may comprise the aircraft circling around a fixed point, for example the location of the winch on the ground, during the charging phases, conversion phases, and/or gliding phases. Where the expression “circling” is used, the skilled person will appreciate that the path is not strictly limited to tracing a circle, and may trace an alternative path, for example, elliptical. The method may comprise the aircraft tracing an approximately lemniscate or lobed path during the charging phases, conversion phases and/or gliding phases.

The charging phase may comprise the tethered aircraft being pulled towards the winch by the tether, such that the speed of the aircraft is increased. The winch may be driven to wind the tether around the winch drum during the charging phase. The altitude of the aircraft may decrease during the charging phase.

The charging phase may comprise flight control surfaces on the tethered aircraft being manipulated to control the pitch of the aircraft, such that aerodynamic surfaces, for example wings, of the aircraft generate more lift, thereby increasing the altitude of the aircraft. Such an arrangement will be familiar to those skilled in the art, and is similar to the physics behind the flying of a kite. In such an arrangement, there may be a tether expeller to actively expel the tether, such that the tether does not unduly limit or hinder the altitude increase of the aircraft.

The gliding phase allows the aircraft to be positioned for the repetition of multiple charging phases and conversion phases. This is in contrast to, for example, a conventional tow launch, where only a single charging phase and conversion phase is applied. By allowing repetition of multiple charging phases and conversion phases, the altitude and/or velocity increase of the aircraft is potentially much greater utilising the present invention than in conventional arrangements.

According to a second aspect of the invention, there is provided a tethered propulsion system, the tethered propulsion system comprising:
a winch,
a tether extending from the winch,
an aircraft attachment mechanism at the free end of the tether,
a control system configured to control the movement of the winch.

The tethered propulsion system may be used according to the method according to the first aspect of the invention. The winch may comprise a drive unit, for example a motor. The motor may be an electric motor. The motor may be driven by any suitable fuel, for example liquid or gas fuel, or electricity provided by batteries or a power supply network. The drive unit may drive the winch to reel the tether in and out. The winch may comprise a winch drum around which the tether may be reeled in and out. The drive unit may be controlled by the control system.

The winch control system may comprise a tether expeller. The tether expeller may be configured to actively expel the tether when activated. The tether expeller may be controlled by the control system, and activated as necessary when the altitude of an aircraft attached to the tether increases rapidly, so as not to retard the altitude gain of the aircraft.

The winch may be mounted to a rotatable platform. The tether may comprise a freely rotating coupling. The rotatable platform and/or freely rotating coupling may allow the flight control system to drive a circular and/or lemniscate, and/or lobed flight path without twisting of the tether.

The flight control system may comprise a tether platform to which an aircraft may be removably connected, the tether platform located at the free end of the tether. The removable connection between the tether platform and an aircraft may comprise a quick release mechanical coupling, and/or an active decoupling arrangement. Preferably, the removable connection is reusable after disconnection with an aircraft. The tether platform may be interchangeable with alternative tether platforms, each tether platform being optimised for connection for one or more aircraft. Such an arrangement may allow the use of the flight control system with several different types of aircraft with only minimal changes to the system being necessary. The tether platform may comprise a mating interface arranged to mate with a corresponding mating interface on the aircraft. The mating interface may comprise a controllable release mechanism, such that the aircraft may be released from the tether platform once the desired altitude is reached. The controllable release mechanism may comprise one or more actuators which are controllable to release the mating interface of the tether platform from the mating interface on the aircraft. The tether platform may comprise a cradle, the cradle arranged to be releasably connected to the aircraft. The cradle may support the aircraft at multiple points, potentially increasing the structural resilience of the aircraft during the increase in altitude and/or velocity. The tether platform may comprise a mothership to which the aircraft is releasably connected. The mothership may support a plurality of aircraft simultaneously. The mothership may comprise aerodynamic surfaces and/or flight control surfaces which allow the mothership to remain flying after the release of the aircraft. The mothership may comprise aerodynamic surfaces, and/or flight control surfaces, which provide additional aerodynamic lift to the aircraft.

The flight control system may comprise an aircraft connector, to which an aircraft may be removably connected, the aircraft connector located at the free end of the tether. The removable connection between the aircraft connector and an aircraft may comprise a quick release mechanical coupling, and/or an active decoupling arrangement. Preferably, the removable connection is reusable after disconnection with an aircraft. The aircraft may comprise a connection point configured for connection to the aircraft connector.

The tether may comprise a slack compensator. The slack compensator may be activated when the tether is slack and extended in a position where the tether may contact the ground. The slack compensator may be an unmanned aerial vehicle, for example a drone. The unmanned aerial vehicle may traverse the length of the tether and provide support to the tether to ensure the tether does not contact obstacles on the ground. The same unmanned aerial vehicle may be used to support the free end of the tether if the free end is released from the aircraft. Alternatively, or additionally, a boom arm may be used to elevate the tether length to a minimum height to ensure it does not contact obstacles. The boom arm may be positioned where the vertex of the tether is expected to be. The boom arm may also be used to prevent collisions between the free end of the tether and the winch.

The control system may be configured to receive flight telemetry data and/or weather data from an aircraft attached to the tether, or the tether platform connected to the tether.

According to a third aspect of the invention, there is provided a method of decreasing the altitude of a tethered aircraft, wherein tension in the tether increases, such that the lift force generated by the aircraft is overcome and the altitude of the aircraft is decreased. The method may comprise the step of tethering an aircraft to the tether prior to decreasing the altitude of the tethered aircraft. The tethering may comprise a docking procedure where the aircraft is brought proximate to the free end of the tether, and the free end of the tether may comprise a powered tether connection platform, for example being powered by a drone or other UAV.

According to a fourth aspect of the invention, there is provided an aircraft tether platform, the aircraft tether platform comprising a tether connection point and at least one aircraft connection point.

The aircraft tether platform may comprise a power unit. The power unit may provide thrust to the aircraft tether platform in order to facilitate the controlled landing of the tether platform when returning to the ground from an airborne position. The aircraft tether platform may comprise a deployable parachute. The parachute, when deployed, may facilitate the controlled landing of the tether platform when returning to the ground from an airborne position.

According to a fifth aspect of the invention, there is provided an aircraft, the aircraft configured to be coupled to an aircraft tether platform according to the fourth aspect of the invention. The aircraft may comprise one or more releasable connectors, each releasable connector configured to be releasably engaged with corresponding connectors on the aircraft tether platform.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic view of a tethered propulsion system according to a first embodiment of the invention;

FIG. 2 shows a first flight pattern according to an embodiment of the invention;

FIG. 3 shows a second flight pattern according to an embodiment of the invention;

FIG. 4 shows various vector diagrams of an aircraft gaining altitude;

FIG. 5 shows various variations of tethered propulsion systems according to embodiments of the invention;

FIG. 6 shows how a flight pattern may be adjusted in dependence on the wind conditions experienced by an aircraft;

FIG. 7 shows how an aircraft may be controlled using tethered propulsion to maintain the altitude of the aircraft;

FIG. 8 shows various methods that may be used for tether recovery;

FIG. 9 shows how an aircraft may be aerially positioned for tethered propulsion launch;

FIG. 10 shows various methods that may be used to attach a tether to an aircraft; and

FIG. 11 a and b show various methods of slack compensation that may be used.

### DETAILED DESCRIPTION

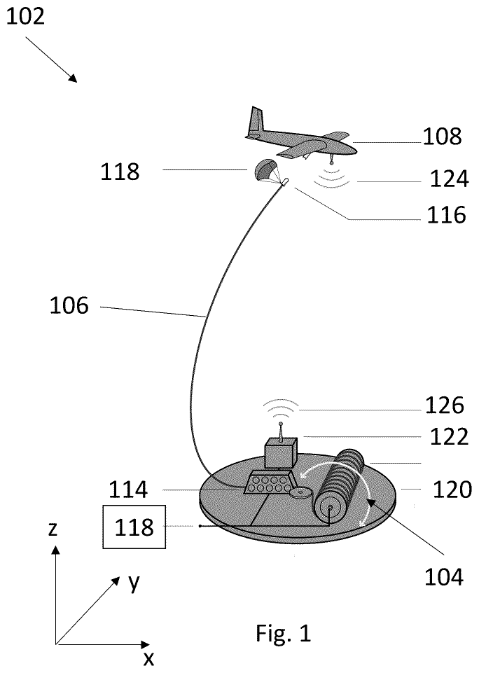

FIG. 1 shows a tethered propulsion system 102. The tethered propulsion system comprises a winch 104, a tether 106 extending from the winch 104, and an aircraft 108. The winch 104 comprises a winch drum 110, powered by a winch actuator 112, which may drive the winch drum 110 in a winding or unwinding direction, such that the tether 106 is wound, or unwound from the winch drum 110. The tethered propulsion system 102 further comprises a tether expeller 114 through which the tether 106 extends, which may be activated to expel the tether 106 at a fast speed. In this embodiment, the aircraft 108 is connected to the tether 106 via a releasable connection point 116. In an alternative embodiment, the aircraft 108 may be releasably connected to a tether platform, the tether platform being connected to the tether 106. The tether platform may comprise a mating interface arranged to mate with a corresponding mating interface on the aircraft, and/or a cradle supporting the aircraft at multiple points, and/or comprise a mothership to which the aircraft is releasably connected.

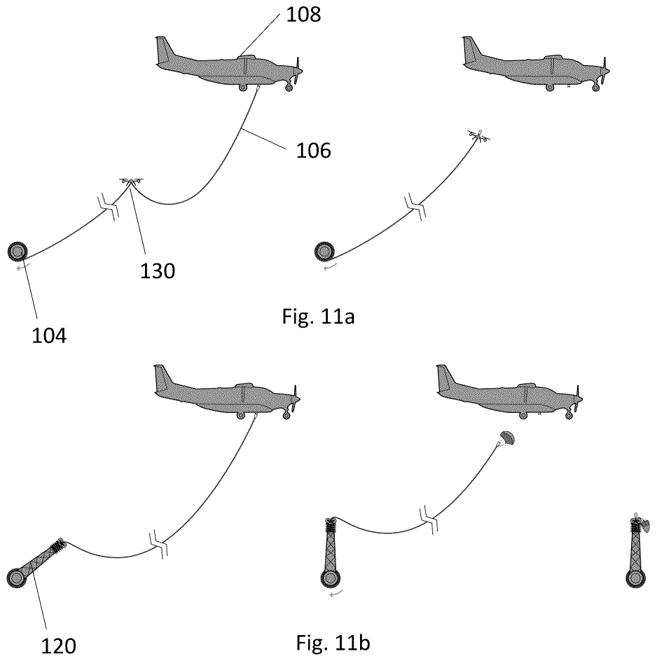

The free end of the tether 106, which is connected to the aircraft 108 includes a deployable parachute 118, which may be deployed when the tether 106 is disconnected from the aircraft 108 in order to allow the free end of the tether 106 to return to the ground in a controlled manner. The winch 104 is mounted to a rotatable platform 120 which may be rotated 360 degrees relative to the ground on which the platform 120 is mounted. A control unit 122 is arranged to receive flight telemetry data from the aircraft 108 and control the tethered propulsion system 102, including the activation of the winch 104 and the tether expeller 114. The control unit 122 is also arranged to receive weather data, such as wind speed and direction both in and around the location of the aircraft 108. The control unit 122 is further configured to receive commands, such as “launch”, and analyse the weather conditions and flight telemetry data once the aircraft is moving, in order to formulate a flight pattern suitable for launching the aircraft 108 as desired. The control unit 122 then controls the various active elements of the flight control system 102 in order to launch the aircraft 108. The control unit 122 comprises a wireless communications unit 126 which communicates with a wireless communications unit 124 on the aircraft 108. The wireless communication is two-way, allowing the aircraft 108 to send flight telemetry data and weather conditions data to the control unit 122, and the control unit to send flight control data to the aircraft 108, so that the flight control surfaces on the aircraft 108 can be controlled as required. As shown in FIG. 11a, the tether 106 may include a slack compensator in the form of a drone 130 or other powered aircraft, which may be activated when the tether is extended and slack enough that the tether may contact the ground. Alternatively, the slack compensator may be in the form of a boom arm as shown in FIG. 11b. The slack compensator may be activated to prevent damage to the tether or the surroundings in this scenario. Also not shown is a tether sensor which monitors the tension of the tether 106. This tension is fed back to the control unit 122 to facilitate the analysis of the flight telemetry data and weather conditions, and will be factored into whether the winch 104 is winding or unwinding the tether 106, and may also determine how fast this is done. There may be threshold limits of tension which are used to prevent damage to the tethered propulsion system 102.

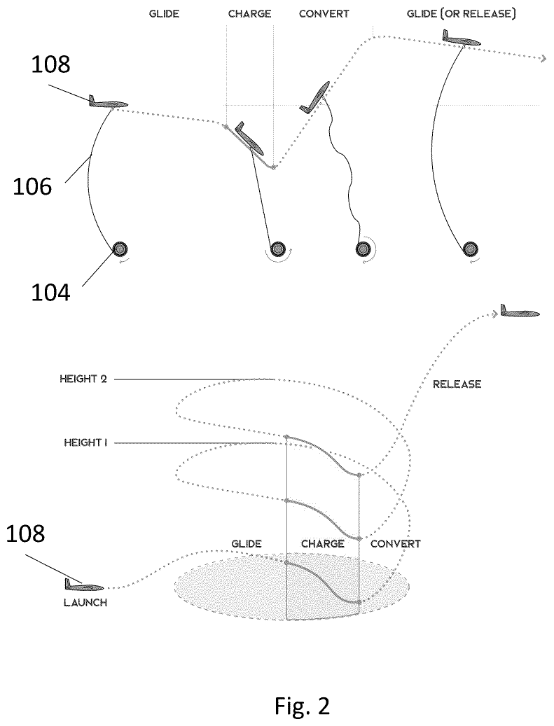

FIG. 2 shows a flight pattern which may be utilised by the tethered propulsion system 102 in order to launch the aircraft 108 from the ground. The flight pattern is shown in a schematic three-dimensional representation at the bottom half of the figure, with the top half of the figure representing the altitude change of the aircraft in a flattened plane. Initially, the aircraft 108 is stationary on the ground, prior to the winch 104 being activated by the control unit 122 in response to a “launch” command, such that the tether 106 is wound around the winch drum 110. This creates tension in the tether 106, which will accelerate the aircraft 108 to a point where the speed of the aircraft 108 is such that the aerodynamic effect of the wings lifts the aircraft 108 off the ground. This will be recognisable to the skilled person as being similar to a conventional winch launch. The flight pattern then goes into various charging phases, conversion phases, and gliding phases as will be described further below. The result of the repetition of the charging phases, conversion phases, and gliding phases is to further increase the altitude of the aircraft 108, to a height which would not be possible with a conventional winch launch, at least without an impractically long tether and runway. As can be seen in FIG. 2, the charging phases, conversion phases, and gliding phases are activated as the aircraft 108 circles the winch 104, with the result that the increase in altitude takes place over a relatively constrained space in the X-Y plane. The skilled person will appreciate that the X-Y plane being referred to is the ground plane, with the Z direction being vertical and a measure of altitude. In contrast to a conventional winch launch, in which the aircraft 104 would be towed in an approximately straight line, thus extending a long way in the X-Y plane, the present invention utilises an approximately cylindrical or conical flight envelope, which extends vertically upwards with the winch 104 in the approximate centre of the envelope. Depending on the wind conditions during the launch, the flight corridor may extend at various angles to the vertical, as will be understood by the skilled person.

As can be seen in FIG. 2, during the charging phase, the winch 104 is activated to tension the tether 106 and accelerate the aircraft 108 into a dive. This increases the speed of the aircraft 108, and the increased speed is then used in a conversion phase once the tension in the tether 106 is released to allow the dive to be reversed and the aircraft increases in altitude compared to the altitude prior to the charging phase, with the aircraft moving into a gliding phase once the conversion phase has been completed. The gliding phase controls the position of the aircraft 108 such that the aircraft 108 is moved into a position in which the charging phase and the conversion phase can be repeated. As can be seen, the charging phase, the conversion phase, and the gliding phase, are repeated as the aircraft flies about the winch 104. In order that the tether 106 is not unduly twisted by the direction changes of the aircraft, the rotating platform 120 is rotated as required to ensure the winch drum 110 remains approximately squarely aligned with the direction of travel of the aircraft 108. Once the aircraft 108 has reached the desired altitude, the flight pattern may move into a “maintain” phase, where the aircraft 108 is controlled to stay at approximately the same altitude, and remains connected to the tether 106. Alternatively, once the aircraft 198 has reached the desired altitude, the flight pattern may move into a “release” phase, where the releasable connection point 116 is released, thereby releasing the aircraft 108 from the tether 106. The deployable parachute 118 is then deployed to allow the free end of the tether 106 to return to the ground in a controlled manner. If the aircraft 108 is a powered aircraft, the release phase may include powering the engines of the aircraft to allow flight after the tether 106 has been released. If the aircraft 108 is a sail aircraft, no such powering of the engines may be required.

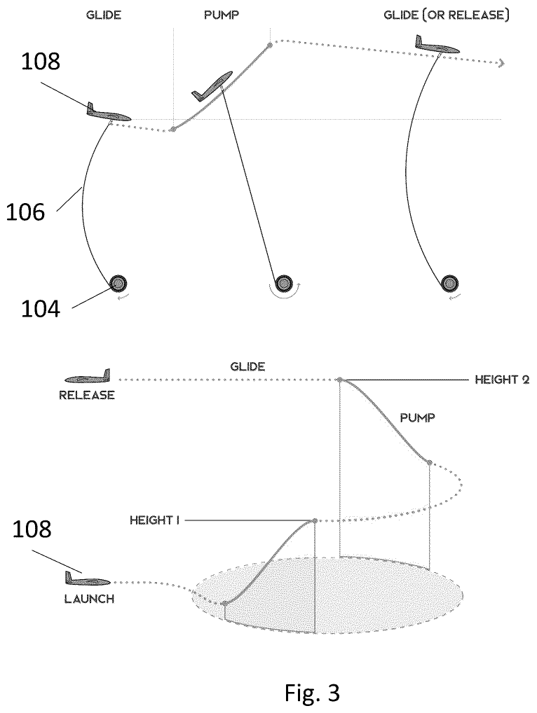

FIG. 3 shows an alternative flight pattern to that shown in FIG. 2, which utilises the wind conditions experienced by the aircraft 108, and manipulation of flight control surfaces on the aircraft 108, to drive the charging phase of the flight pattern. In this flight pattern, the wind speed incident on the aircraft 108 is utilised in the charging phase to increase the lift of the aircraft 108 and reduces or eliminates the required amount of additional energy which is input to the aircraft 108 via the winch 104. The winch 104 unwinds the tether 106 from the winch drum 110 in the conversion phase to allow the aircraft 108 to take advantage of this lift and increase in altitude. However, the increase in altitude of the aircraft will increase the tension in the tether 106, and this increase in tension may be detected to trigger the unwinding of the tether 106 by the winch 104.

FIGS. 2 and 3 show two alternative flight patterns, but the skilled person will appreciate that the flight patterns may be combined in dependence on the flight telemetry data and the wind and weather conditions. The control unit 122 determines what flight pattern is used based on the real time analysis of the flight telemetry data and the wind and weather conditions, which will be constantly changing.

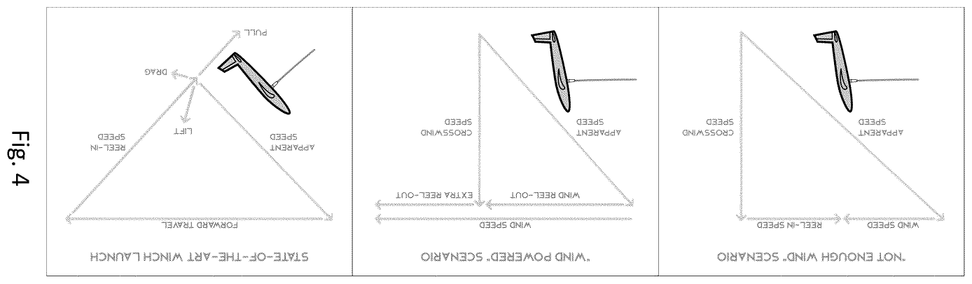

FIG. 4 shows three free-body diagrams demonstrating the various forces acting the aircraft 108 in various scenarios. In the first scenario as shown on the left of the figure, the aircraft 108 is undergoing a charging phase as described with reference to FIG. 2. In this situation, the wind is not hitting the wings of the aircraft 108 fast enough to give enough lift to increase the altitude of the aircraft 108 without additional energy being input into the system. This energy is input into the system via the tether 106, as the winch 104 rapidly winds in the tether 106. Therefore, the wind speed combines with the speed of the winding in tether 106, along with the crosswinds experienced by the aircraft 108, to result in an apparent speed as shown. The crosswinds are as a result of the constantly changing direction of the aircraft, in this case due to the approximate circling of the aircraft 108 relative to the winch 104. The apparent speed can be seen to be much greater than the wind speed, and this increase in energy of the aircraft is used in the conversion phase with appropriate adjustment of the aerodynamic control surfaces of the aircraft 108 to increase the altitude of the aircraft 108.

In the second scenario, shown in the middle of the figure, the wind speed is greater than in the first scenario. The wind speed is great enough that the aerodynamic control surfaces of the aircraft 108 may be adjusted to increase the altitude of the aircraft 108, and a limiting factor on the speed of altitude gain is the tether 106. In order that the tension in the tether 106 does not substantially increase as the aircraft 108 move away from the winch 104, the tether expeller 114 is activated to force out the extension of the tether 106 so the aircraft 108 can gain altitude without the increase in tension in the tether 106 from holding back the climb too much. The energy required to expel the tether is relatively small compared to the energy required to draw in the tether in the first scenario, and it can be seen that the more energy efficient scenario in which to gain altitude is the second one. However, as this is dependent on the wind conditions, the first scenario presents a useful way of increasing the altitude of an aircraft when the weather conditions are less than ideal.

The third scenario, shown on the left of the figure, shows the free-body diagram of a conventional winch launch. The aircraft is launched travelling in an approximately constant direction, which removes the crosswind speeds that are shown in the first two scenarios.

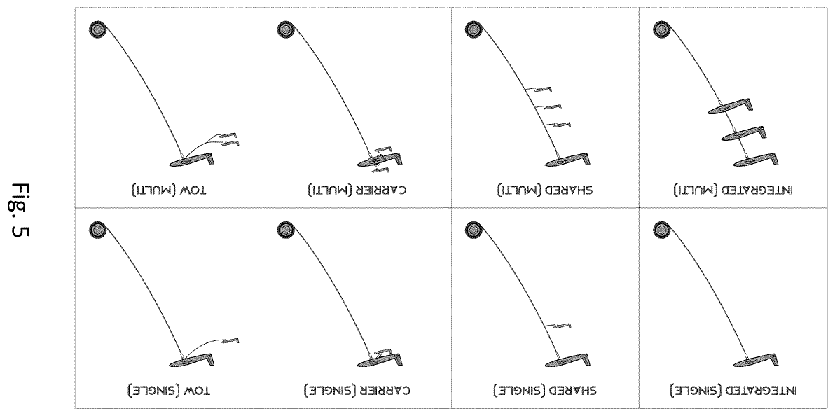

FIG. 5 shows alternative embodiments of the invention, where various modifications or additions have been made to the system described with reference to FIG. 1. As can be seen, various multiple aircraft embodiments are shown, some where multiple aircraft are attached at different places to the same tether, and some where the multiple aircraft are towed or carried by a tether connection platform, which may also include aerodynamic surfaces which allow the tether connection platform to be raised in the same way as the aircraft.

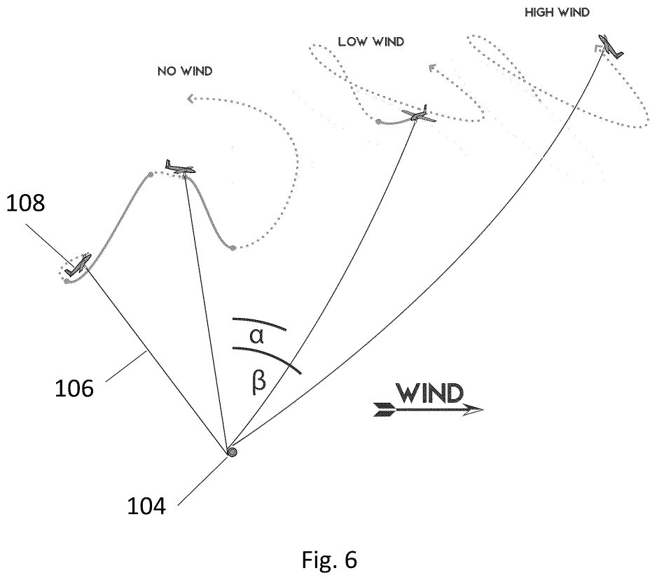

FIG. 6 shows how the flight pattern, and in particular the angle of the axis around which the aircraft is circulated, may change as the wind strength increases. The stronger the wind, the more angled to the perpendicular the axis around which the aircraft is circulated may be.

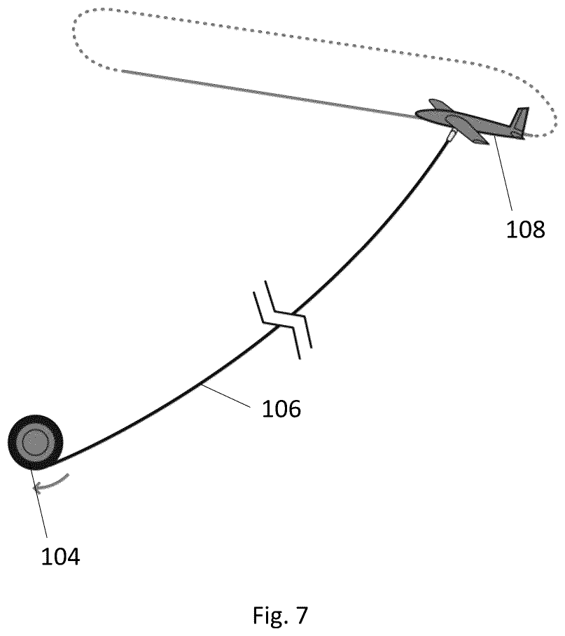

FIG. 7 shows how the aircraft 108 is controlled using tethered propulsion to maintain the altitude of the aircraft through hysteresis, by alternating between charge, conversion and glide phases. This may be also referred to as a survey mode as when controlled in this way the aircraft 108 may be surveying the area over which it is circling. By combining this method of control with an onboard propulsion system, it is possible to have tighter control of the altitude of the aircraft.

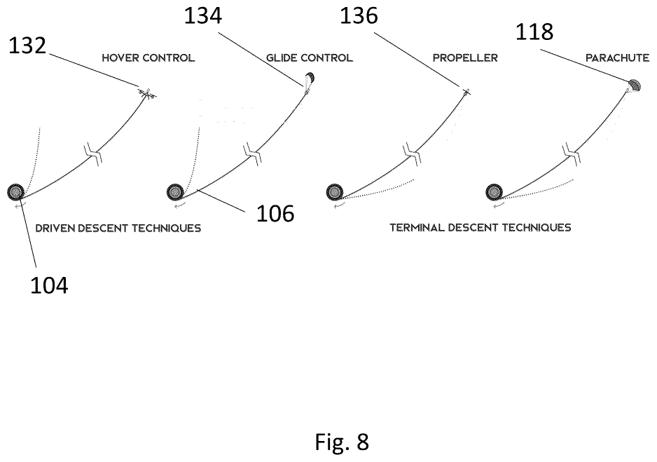

FIG. 8 shows methods used for tether recovery. Tether 106 recovery may include one or more of hover control, glide control, propeller, or parachute tether recovery. Hover and glide control tether recovery can be referred to as driven descent techniques. This is because the free end of the tether 106 is driven to a selected position by the controllable device, such as a powered flight system 132 or glider 134. Alternatively, propeller and parachute tether recovery are terminal descent techniques as they allow the tether 106 to fall at its terminal velocity without actively controlling the free end of the tether 106. In all cases, the winch reels in the tether 106 effectively on the ground.

In the example of FIG. 8, hover control uses a powered flight system 132, which may be a drone to suspend the airborne tether length. As the ground winch reels in the tether, the drone positions the free end of the tether and maintains minimum tension in the tether. This provides a high degree of tether position and tension control. Alternatively glide control may be used to reel in the tether 106. The method of glide control involves using a glider 134 to suspend the airborne tether length. The winch 104 reels in the tether, and the glider maintains minimum tension on the tether and steers itself along a trajectory. This enables the tether to remain within a pre-defined controlled ground area around the ground winch 104. Another option is the use of a propeller 136 to add lift to the tether and therefore maintain tension on the tether. This reduces the terminal velocity of the tether 106. By adjusting the propeller 136 pitch and speed, further control of the tether 106 can be achieved. Alternatively, a parachute 118 may be used to control the descent of the tether 106. By controlling the descent of the tether greater control and safer operation is achieved.

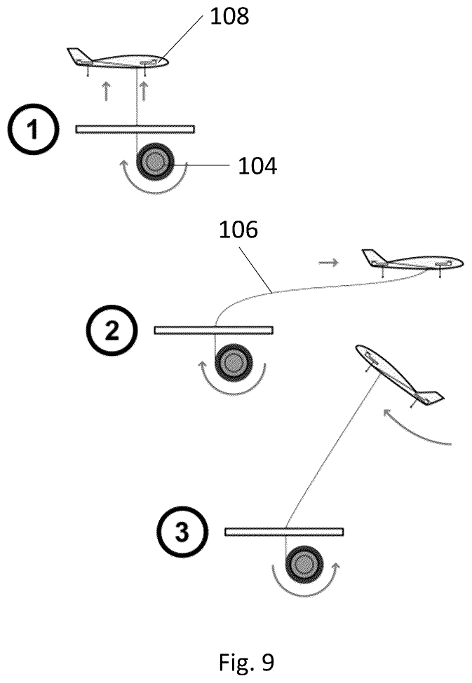

FIG. 9 shows how an aircraft 108 may be positioned for tethered propulsion launch. Tethered propulsion technology may also be used with an aircraft designed to take off vertically. The vertical take-off capabilities of an aircraft 108 can be used to aerially position the aircraft downwind of the winch 104 to prepare it for tethered propulsion launch.

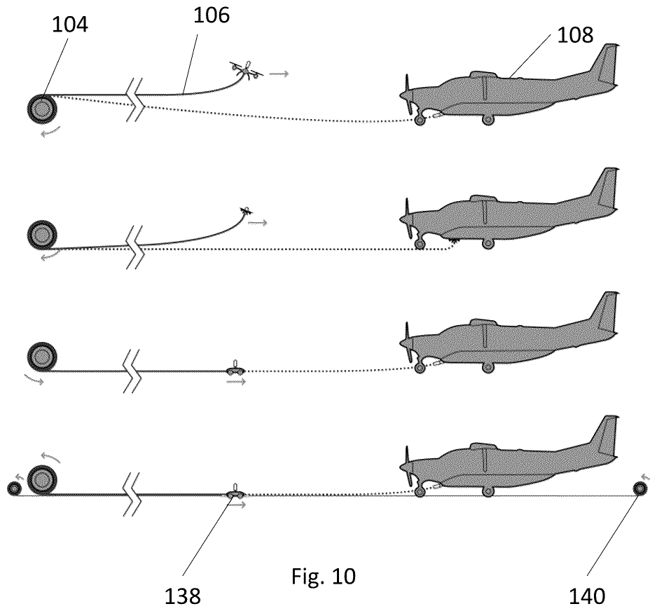

FIG. 10 shows methods that may be used to attach a tether to an aircraft. It can be seen that a powered flight system or drone can be used to attach the tether 106 to the aircraft 108. In some cases the drone 132 will then remove itself from the tether and the aircraft, in alternative cases, the drone 132 will remain attached to the tether and the aircraft. In this case, the drone 132 can then be used to support the weight of the tether when it is released from the aircraft. This enables the aircraft to be readied for a tether propulsion launch without the presence of human personnel.

Alternatively, a ground vehicle 138 can be used to carry the free end of the tether 106 to the aircraft 108. The ground vehicle 138 may be used to secure the free end of the tether into a receiving interface on the aircraft. The ground vehicle may then detach itself from the tether and clear the area around the aircraft. Alternatively, the vehicle may be controlled by winches 140 on either end of the airstrip and used to pull the vehicle in either direction. A mechanism on board the vehicle may be used to attach the tether 106 to the aircraft 108, alternatively a mechanism on board the aircraft 108 may be used to attach the tether 106 to the aircraft 108.

FIGS. 11a and 11b show methods of slack compensation that may be used. As long tether lengths are used, it is possible during operation the tether will contact the ground. This creates risk for the flight of the aircraft, and the personnel and equipment on the ground. FIG. 11a shows the use of a drone to traverse the length of the tether and provide support wherever it is needed to ensure the tether does not contact obstacles on the ground. The same drone may also be used for attaching the tether and removing the tether as shown in FIGS. 8 and 10 respectively. Alternatively, as shown in FIG. 11b, a boom arm may be used to elevate the tether length to a minimum height to ensure the tether does not contact obstacles on the ground. This structure may be placed where the vertex in the airborne tether's curvature is expected to be. The boom arm may also be used to prevent high-speed collisions between the free end of the tether and the winch during reel-in by including an impact absorption mechanism.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The method described above covers the aircraft 108 increasing in altitude through the use of various types of charging phases, either wind driven or winch driven. The invention may also be used to reduce the altitude of a tethered aircraft through the gradual reduction in the length of the tether as the winch winds the tether around the winch drum. The aircraft may be controlled to perform an extended glide around the winch during this operation, so that the altitude is reduced smoothly and slowly. The aircraft may be brought to the ground in such a way, and the landing may be controlled by a braking system on the aircraft, the tensioning of the tether, or a combination of the two.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of controlling the altitude and/or velocity of a tethered aircraft, the method comprising the steps of:
a charging phase, in which the energy of the aircraft is increased,
a conversion phase following the charging phase, in which the increased energy is utilised to increase the altitude and/or velocity of the aircraft;
a gliding phase, in which the aircraft is positioned for a further charging phase and conversion phase; and
repeating the charging phase and conversion phase at least once.

2. A method as claimed in claim 1, wherein the charging phase comprises the tension in the tether being increased and thereby imparting additional kinetic energy to the aircraft.

3. A method as claimed in claim 2, wherein the tether directly increases the velocity of the aircraft, and the conversion phase utilises this increased velocity to increase the altitude of the aircraft with appropriate manipulation of flight control surfaces of the aircraft.

4. A method as claimed in any preceding claim, wherein the charging phase comprises flight control surfaces of the aircraft being manipulated to increase the lift imparted by the wind conditions experienced by the aircraft, and the conversion phase utilises this increased lift to increase the altitude of the aircraft.

5. A method as claimed in any preceding claim, wherein the gliding phase comprises the tension in the tether decreasing

6. A method as claimed in any preceding claim, wherein tethered propulsion is used to maintain the aircraft's altitude by alternating between charge, conversion and glide phases.

7. A method as claimed in any preceding claim, comprising the step of untethering the aircraft once the desired altitude and/or velocity is reached.

8. A method as claimed in claim 7, wherein the aircraft comprises a connection point releasably connected to the tether.

9. A method as claimed in claim 7, wherein the aircraft is releasably connected to a tether platform, the tether platform being connected to the tether.

10. A method as claimed in any of claims 7 to 9, comprising the step of deploying a parachute from the tether or tether platform once the aircraft has been untethered.

11. A method as claimed in any of claims 7 to 9, comprising the step of activating a powered flight system attached to the tether once the aircraft has been untethered.

12. A method as claimed in any preceding claim, comprising the step of the aircraft collecting flight telemetry data.

13. A method as claimed in any preceding claim, comprising the step of collecting weather data in the vicinity of the aircraft.

14. A method as claimed in claim 12 or claim 13, comprising the step of analysing the flight telemetry data and/or weather data and controlling the charging phases and gliding phases in dependence on the analysis.

15. A method as claimed in claim 14, comprising the step of the control system controlling the winch in dependence on the analysis of the flight telemetry data and/or weather data.

16. A method as claimed in any preceding claim, comprising the aircraft starting off stationary on the ground.

17. A method as claimed in any preceding claim, wherein the method comprises a method of launching an aircraft from the ground.

18. A method as claimed in any preceding claim, wherein the method comprises a method of launching the aircraft from the air.

19. A method as claimed in any preceding claim comprising the step of changing the direction of travel of the aircraft during the charging phases and gliding phases.

20. A method as claimed in any preceding claim comprising the step of the aircraft circling around a fixed point during the charging phases and gliding phases.

21. A method as claimed in any preceding claim, further comprising the step of a tether expeller actively expelling the tether, such that the tether does not unduly limit the altitude increase of the aircraft.

22. A tethered propulsion system, the tethered propulsion system comprising:
a winch,
a tether extending from the winch,
an aircraft attachment mechanism at the free end of the tether,
a control system configured to control the movement of the winch.

23. A tethered propulsion system as claimed in claim 22, comprising a drive unit, the drive unit arranged to be controlled by the control system.

24. A tethered propulsion system as claimed in claim 22 or 23, comprising a tether expeller configured to actively expel the tether when activated.

25. A tethered propulsion system as claimed in any of claims 22 to 24, wherein the winch is mounted to a rotatable platform.

26. A tethered propulsion system as claimed in any of claims 22 to 24, wherein the tether comprises a freely rotating coupling.

27. A tethered propulsion system as claimed in any of claims 22 to 26, wherein the flight control system comprises a tether platform to which an aircraft may be removably connected, the tether platform located at the free end of the tether.

28. A tethered propulsion system as claimed in claim 27 wherein the tether platform is interchangeable with alternative tether platforms, each tether platform being optimised for connection for one or more aircraft.

29. A tethered propulsion system as claimed in any of claims 22 to 26, comprising an aircraft connector, to which an aircraft may be removably connected, the aircraft connector located at the free end of the tether.

30. A tethered propulsion system as claimed in any of claims 22 to 29, wherein the tether comprises a slack compensator.

31. A tethered propulsion system as claimed in any of claims 22 to 29, wherein the control system is configured to receive flight telemetry data and/or weather data from an aircraft attached to the tether, or the tether platform connected to the tether.

32. A method of decreasing the altitude of a tethered aircraft, the method comprising the steps of:
a gliding phase, wherein tension in the tether increases, such that the lift force generated by the aircraft is overcome and the altitude of the aircraft is decreased.

33. An aircraft tether platform, the aircraft tether platform comprising a tether connection point and at least one aircraft connection point.

34. An aircraft, the aircraft configured to be coupled to an aircraft tether platform according to claim 33.
